(19) United States
(12) Patent Application Publication
(10) Pub. No.: US 2011/0278391 A1
(43) Pub. Date: Nov. 17, 2011

(54) DRAGONFLY UNMANNED AERIAL VEHICLE

(76) Inventor: Andrey KOTLER, Nahariya (IL)

(21) Appl. No.: 12/781,039

(22) Filed: May 17, 2010

(51) Int. Cl. B64C 33/00

(52) U.S. Cl. 244/22

(57) ABSTRACT

A micro aerial vehicle apparatus capable of flying in different flight modes is disclosed. The apparatus includes a fuselage; at least one pair of blade-wings; and an actuator for actuating the blade-wings by flapping the blade-wings in dissonance or resonance frequencies.

### FIELD OF THE INVENTION

The present invention relates to an ornithopter. More particularly it relates to a dragonfly unmanned aerial vehicle.

### BACKGROUND OF THE INVENTION

Micro Aerial Vehicles (MAV), are small flying objects, which are designed for flying and performing a variety of missions in confined, difficult, or dangerous zones such as: battle fields, contaminated areas, tornados, interior of buildings, forest canopies, tunnels and caves.

There are several approaches for designing a MAV. One approach is based on rotating a set of rigid wings. A helicopter is an example of an aerial vehicle, which uses this approach. A helicopter flies using a rotary wing design, wherein the wings or blades rotate in a plane parallel with the longitudinal axis of the fuselage. Another approach is based on aerial vehicles, which create lift and thrust by a flapping motion of elastic wings. Some of these systems include biologically inspired systems that utilize an ornithopter (flapping wing) or ornithopter system, to enable the maneuvers and flight modes exhibited by insects and humming birds. As demonstrated by birds, flapping wings offer potential advantages in maneuverability and energy savings compared with fixed-wing aircraft. An ornithopter aircraft has at least a fuselage and four rigid wings which are tandem mounted, in pairs, on opposite sides of the fuselage, in what might be called a “dragonfly configuration”. The forward wings in a first of the tandem pairs on one side of the fuselage beats upwardly simultaneously with the diagonally opposed rear wing in the tandem pair on the opposite side of the fuselage, while the remaining two wings are beating downwardly. Then, the wings reverse their direction of travel. The previously upwardly moving wings beat downwardly while the previously downwardly moving wings beat upwardly. The pitch of the wings is varied throughout the beat to produce lift on the down stroke and minimum air resistance on the upstroke, considering the forward speed of the aircraft or the lack thereof. The pitch of the wings is set at the sink angle of a glider wing flying at the same speed. A differential between the pitch or stroke of the wings on opposite sides of the fuselage controls direction and banking of the ornithoptic vehicle.

Reviewing ornithoptics history shortly, the first ornithoptics capable of flight were constructed in France in the 1870s. They were powered by rubber band or, in one case, by gunpowder charges. AeroVironment, Inc. has developed a remotely piloted ornithopter the size of a large insect for possible spy missions. It also developed a half-scale replica of the giant pterosaur. The model had a wingspan of 5.5 meters (18 feet) and featured a complex, computerized control system, just as the full-size pterosaur relied on its neuromuscular system to make constant adjustments in flight. Ornithopters are also built and flown by hobbyists. These range from light-weight models powered by rubber band, to larger, radio control ornithopter. Many attempts at manned ornithopter flight have been made, only a few of which have been successful.

The ornithopter eliminates the complexity required for overcoming dynamic rotational forces of flight at the expense of flight speed and incidence of reciprocal vibration. The lifting capacity of the ornithopter can be substantial and flight operation is less complex than a helicopter. U.S. Pat. No. 6,206,324 discloses an ornithopter with multiple sets of computer controlled wings which may be programmed to reciprocate in various combinations. A toy ornithopter is disclosed in U.S. Pat. No. 4,155,195. The two sets of wings of the device are mounted on the fuselage in a vertically overlapping design. The sets of wings are reciprocated by crank arms oriented at 90 degrees to each other and powered by a rubber band. The sets of wings reciprocate out of phase with each other in that as one set moves downwardly the other set is moving upwardly. U.S. Pat. No. 6,802,473 discloses an ornithopter which has the capability of slow speed flight as a result of vertical movement of its wings. Two sets of wings are provided with vertical movement of each set of wings 180 degrees out of phase for counterbalancing vertical forces on the fuselage. The direction of the flight path is changed by deflecting the fuselage. U.S. Pat. No. 4,712,749 discloses means and methods for controlling ornithopters. U.S. Pat. No. 6,082,671 teaches a MAV based on the concept of a mechanical insect. The wings are twisted, to optimize lift, during reciprocation by rotation of the wing spar. U.S. Pat. No. 6,540,177 presents a flying object, which flies by a flapping motion of two pair of wings, symmetrically assembled with a compressed air engine and functioning flapping motion up and dawn in the range of 70 degrees, while the individual wing being able to get twisted in the range of 15 degrees.

It is an object of the present invention to provide an ornithopter in a dragonfly configuration that improves the flight performance and at the same time saves energy during flight.

Another object of the present invention is to provide such an ornithopter in a dragonfly configuration that uses different wing position, deflection, orientations and actuation frequencies for different flight modes.

Other objects and advantages of the present invention will become apparent after reading the present specification and consulting the accompanying figures.

### SUMMARY OF THE INVENTION

There is thus provided, in accordance with some preferred embodiments of the present invention, an apparatus capable of flying in different flight modes, the apparatus comprising: a fuselage, at least one pair of blade-wings, and an actuator for actuating the blade-wings by flapping the blade-wings in dissonance or resonance frequencies.

Furthermore, in accordance with some preferred embodiments of the present invention, each blade-wing comprises a main beam with flexibility that is different at one or more places along the beam than the flexibility of the beam at other places along the beam.

Furthermore, in accordance with some preferred embodiments of the present invention, the flexibility at said one or more places along the main beam is greater than the flexibility of the beam at other places along the beam.

Furthermore, in accordance with some preferred embodiments of the present invention, a weight is provided at a distal tip of each blade-wing.

Furthermore, in accordance with some preferred embodiments of the present invention, a damper is further provided on each blade-wing.

Furthermore, in accordance with some preferred embodiments of the present invention, said blade-wings are capable of changing their angle.

Furthermore, in accordance with some preferred embodiments of the present invention, the apparatus comprises of two pairs of blade-wings.

Furthermore, in accordance with some preferred embodiments of the present invention, a first pair of blade-wings is located at an anterior part of the fuselage, and a second pair of blade-wings is located at a posterior part of the fuselage in a tandem set-up.

Furthermore there is thus provided, in accordance with some preferred embodiment of the present invention, a method for flying a micro aerial vehicle apparatus comprising at least one pair of blade-wing, the method comprising flapping the blade-wings in dissonance or resonance frequencies.

Furthermore, in accordance with some preferred embodiment of the present invention, thrust, pitch, yaw and roll flight controls are provided by changing the amplitudes of returnable forward-rotary actuations of each blade-wing.

Furthermore, in accordance with some preferred embodiment of the present invention, altering the position and angle of the blade-wings is provided.

Furthermore, in accordance with some preferred embodiment of the present invention, thrust for high endurance horizontal flight is obtained by exciting frequencies of returnable forward-rotary actuations to be equal to values of natural self-frequency of the blade-wings in first dissonance mode of bending.

Furthermore, in accordance with some preferred embodiment of the present invention, thrust, pitch, yaw and roll flight control are provided by changing amplitudes of returnable forward-rotary actuations of each blade-wing.

Furthermore, in accordance with some preferred embodiment of the present invention, the angle and flapping amplitude of each wing is independent of the other

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1 illustrates an overview of an unmanned aerial vehicle in horizontal flight configuration with its blade-wings in horizontal position, in accordance with a preferred embodiment of the present invention.

FIG. 2 illustrates a design of a blade-wing for a MAV, according to preferred embodiment of the present invention.

FIG. 3 illustrates an actuation mechanism, according to a preferred embodiment of the present invention.

FIG. 4 illustrates a front view of a MAV demonstrating the deformation of the main cantilever beam of a blade-wing in horizontal flight mode with low velocity, in accordance with a preferred embodiment of the present invention.

FIG. 5 illustrates a front view of a MAV demonstrating the deformation of the main cantilever beam of a blade-wing in horizontal flight mode with higher endurance velocity (cruiser), in accordance with a preferred embodiment of the present invention.

FIG. 6 illustrates a different view of a MAV demonstrating a transition blade-wings position in transition flight mode, in accordance with a preferred embodiment of the present invention.

FIG. 7 illustrates a different view of a MAV demonstrating the position of the blade-wing in vertical take-off and landing flight mode, in accordance with a preferred embodiment of the present invention.

FIG. 8 illustrates an upper view of a MAV demonstrating the deformations of the main cantilever beam of a blade-wing in a vertical take-off and landing flight mode in accordance with a preferred embodiment of the present invention.

FIG. 9 illustrates two different optional locations for the maximum flapping amplitude along the length of main cantilever beam of a blade-wing in a MAV.

FIG. 10 illustrates a typical frequency response spectrum of the first and second resonance and first dissonance of a cantilever beam in a blade-wing of a MAV.

### DETAILED DESCRIPTION OF PREFERRED EMBODIMENTS

The present invention introduces a new unmanned ornithoptic micro aerial vehicle (MAV). The innovative MAV creates lift and thrust by a flapping motion of at least one pair of elastic blade-wings with a high aspect ratio (the ratio between the length and width of a wing). The term “blade-wings” is used as in aeronautics “blade” is used for obtaining thrust and “wing” is used for obtaining lift. The blade-wing of the present invention does both.

By altering both the blade-wings flapping frequency and position, numerous flight modes are obtained: horizontal flight with high endurance, horizontal flight with low velocity, vertical take-off and landing, hovering and transition flight.

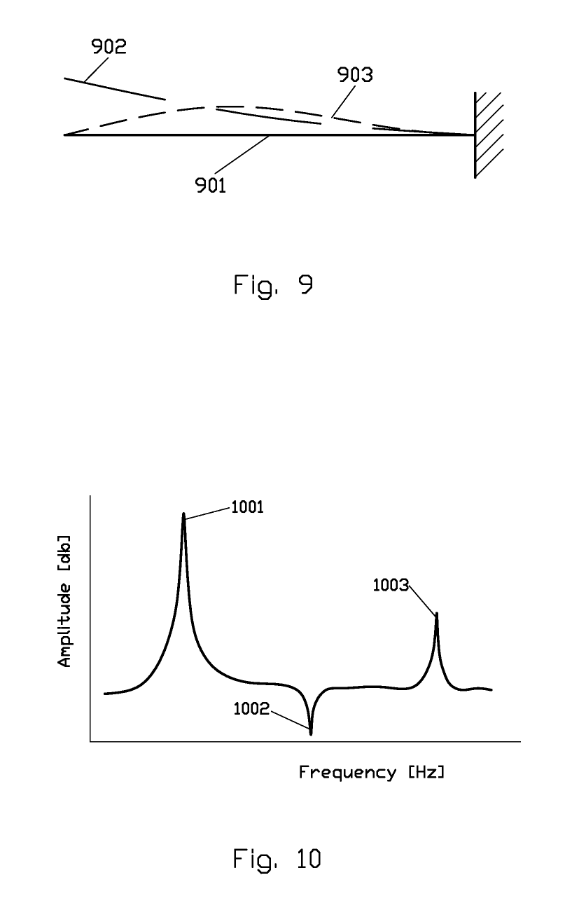

In a preferred embodiment of the invention, thrust, pitch, yaw and roll flight controls, which are required for the different flight modes, are provided by changes in amplitudes of the returnable forward-rotary actuations of each blade-wing. The amplitude is selected according to the flight mode required. In general, for slow flight modes, it is best that the maximal flapping amplitude, along the wing profile (901) is at the tip of the wing (902), as illustrated in FIG. 9. For high endurance flight modes, the aerodynamic conditions are best obtained, when the maximal flapping amplitude is located at the center (903) of the wing.

In a preferred embodiment, by using the first or second resonance frequency, (1001 and 1003 respectively) maximal flapping at the tip of the wing is obtained, on the other hand, by using the first dissonance frequency (1002) maximal flapping is obtained at the center of the wing (FIGS. 9 and 10).

More specifically, in a preferred embodiment, the MAV includes a fuselage (central body), two pairs of blade-wings in “dragonfly configuration”, an anterior pair of blade-wings and a posterior pair of blade-wings. However other embodiments may be used and more or less than two pairs of blade-wings may be used in other configurations. The blade-wings may change their angular positions by tilting them around a joint tilt axis. The base of the blade-wings can move in the torsion, bending and yaw directions by simultaneous forward-backward, up-down and rotary motions. The anterior pair of blade-wings generally moves in the bases in the torsion, bending and yaw directions with a phase difference with respect to the posterior pair of blade-wings, however this is merely an example and other alternatives are possible. Thrust, pitch, yaw and roll flight control is provided by changing in the amplitudes of the simultaneous forward-backward, up-down and rotary motions for each wing. Changes in directions of thrust are providing by pitch-rotate of the blade-wings. The position of all wings as well as their flapping amplitude and frequency, may be asynchronous or synchronous. In addition, in some embodiments, a landing gear, a remote control video camera, batteries, and tail beam may be added.

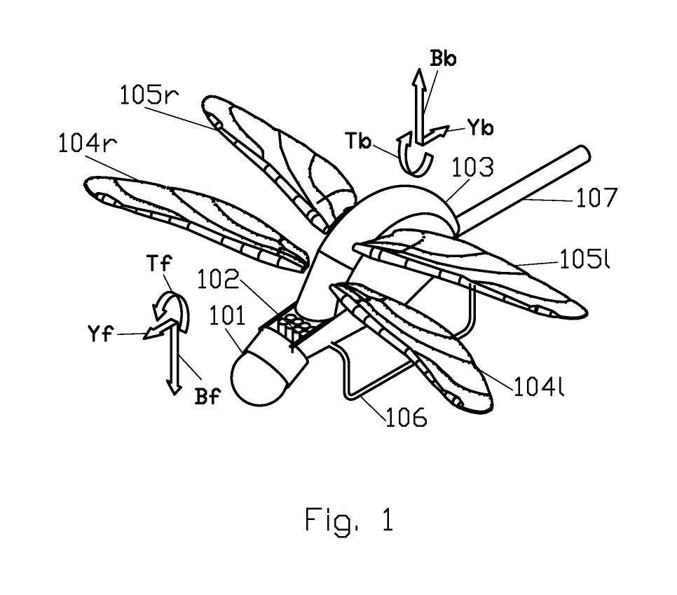

FIG. 1 illustrates a preferred embodiment and configuration of a dragonfly device, suited for horizontal flight mode. The unmanned aerial vehicle includes a fuselage (103), to which other parts are assembled. A remote control video camera (101) and batteries (102) are preferably attached, at the face of the fuselage (for remote guiding and navigation, or for monitoring). Two sets of blade-wing are located to the side of the wings (104, 105). In this embodiment, suited for horizontal flight mode, the orientation of the blade-wings is horizontal. The blade-wings may be moved from their base in the torsion (Tf), bending (Bf), and yaw (Yf) directions (for the anterior pair of blade-wings), and in the torsion (Tb), bending (Bb), and yaw (Yb) directions for the posterior pair of blade-wings with shift of a phase. A tail beam (107), for stabilization and for establishing a center of mass at a desired position, is assembled to the back end of the fuselage. At the bottom of the fuselage (103), a landing gear (106) is preferably provided.

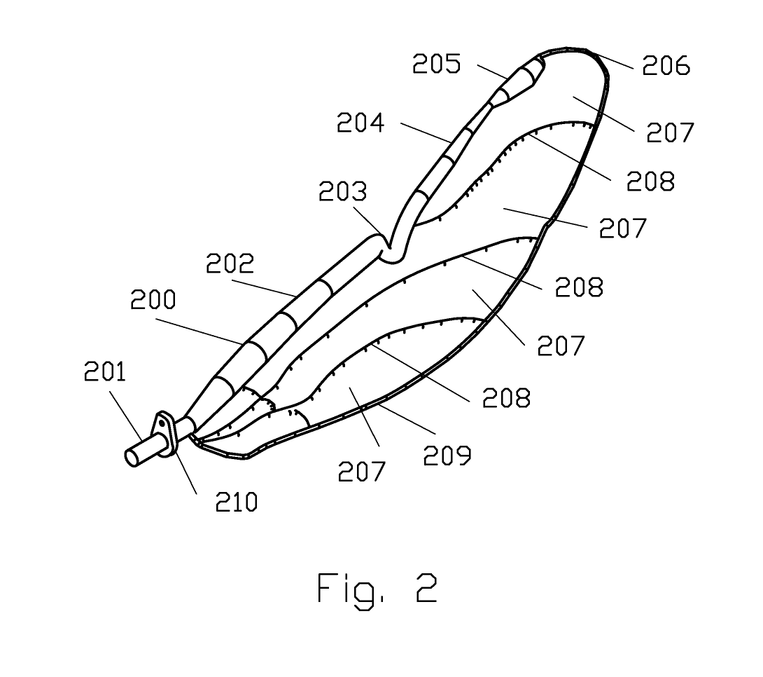

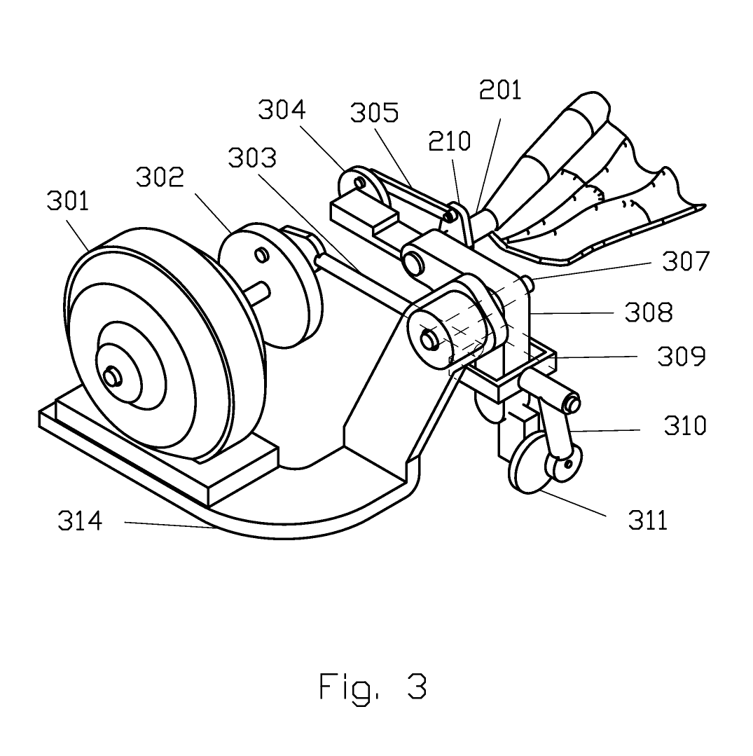

The wings of the MAV are designed to allow the wing to support maximal flapping amplitude of either the tip or the center of the wing, according to the desired flight mode. A preferred design of a blade-wing is detailed in FIG. 2. The blade-wing comprises: A support axis (201), which is used to assemble the wing to the actuation mechanism (seen in FIG. 3); A main beam (200), which extends along the entire length of the wing. In a preferred embodiment the main beam includes several parts with different flexibility characteristics. At the base of the wing, an anterior beam (202) is used to provide support to the geometric shape of the wing; Extending from the anterior beam (202) is a curved beam (203). The curved beam acts as a spring, thus increasing the flapping amplitude of the central portion of the blade-wing, when the first dissonance (anti resonance) mode is applied to the wing. The dissonance frequency is usually applied, when a high endurance horizontal flight mode is required. This frequency ensures high performance and energy saving; Extending from the curved beam (203) is a beam characterized by increased flexibility (204). This beam enables an increased flapping amplitude of the tip of the blade-wing, when the first resonance frequency is used to actuate the wing. The first resonance is usually used for flight modes, which demand greater power consumptions. For example maneuvering and ascending flight modes. At the posterior end of the main beam (200), a weight (205) and damping area (206) are located. They are both responsible for decreasing the flapping amplitude of the tip of the blade-wing, when the first dissonance (anti-resonance) frequency is used; A thin membranes (207) is used for providing aerodynamics force; A secondary elastic beam (208), and a secondary back beam (209) are provided for further supporting the geometric shape of the wing; A pitch control arm (210), which is assembled on the support axis (201) provides pitch control to the wing. It should be clear that this is merely a preferred structure, and other structures may be used as well.

The blade-wings of the disclosed MAV were designed by observing the dimensions, and characteristics of the wings of live Dragonflies. Wing material is typically carbon epoxy composite materials. Exemplary dimensions of the blade-wing (chosen with reference to real dragonfly parameters) may be:

Half Wing Span, b/2=40 mm;

Mean Geometric Chord, S/b=7 mm;

Half Wing Area, S/2=280 mm²

Thickness, Th=less then 0.2 mm;

Aspect Ratio, A.R.=more then 6

Thickness Ratio, T.R.=lees then 2.5% of the chord

Flights Reynolds number, Re=about 6.5E03

Section Maximum Lift Coefficient, CLmax=0.9

Section Angle of Attack (A.O.A.) Max., αomax=11 degrees

Section Minimum Drag Coefficient, Cdmin=0.009

Position of the Aerodynamic Center, 25% of the chord

Section-Moment Coefficient, Cmc/4=0

For αo=±7 degrees,

In addition, for wing:

Induced-drag Coefficient CDi=CL²/π×A.R.

Drag Coefficient CD=Cd+CDi

Angle of Attack α=αo+CL/π×A.R.

However, these are merely exemplary values, and other designs with different dimension, materials and weights are possible. In some preferred embodiments weights may be added to the MAV.

The MAV's blade-wings (FIG. 1 104, 105) are connected to an actuation mechanism. Many different actuation devices are readily available, and may be used in this invention. A preferred embodiment of such a device is illustrated in FIG. 3. The blade-wing actuation mechanism comprises: a frame (314), a two-speed fixed synchronic micro motor (301) and micro servomotors (304 and 311). The fixed motor (301) is connected to a dual-arm beam (308) through a crank (302), and a rod (303). The dual arm beam (308) transfers a periodic rotational movement in both forward and backward directions about axis (307). The periodic motion includes forward-backward, up-down and rational movements (bending, yaw and torsion directions) about axis (307). Micro servomotor (311) controls the amplitude actuation via rod (310), moving framework (309), thus changing the distance between moving framework (309) and axes (307). A constant distance is maintained at all times between base (314) fixed motor (301) and axis (307). A Pitch control micro servomotor (304) provides the pitch control to the blade-wing via rod (305).

The synchronic micro motors and micro servomotors may be of any known type such as, but not limited to: electric, hydraulic, pneumatic and piezoelectric.

In a preferred embodiment, fine-tuning of the actuation amplitude may be obtained by using piezoelectric fiber actuators.

FIGS. 4, 5, and 8 demonstrate examples of different deformations of the main beam of the MAV, for different flight modes. FIG. 4 illustrates a front view of a preferred configuration of a MAV in horizontal flight mode with low velocity. FIG. 5, on the other hand illustrates the deformation of the main cantilever beam in high velocity horizontal flight mode. The deformation of the main beam in vertical flight mode (take-off and landing) is demonstrated in FIG. 8.

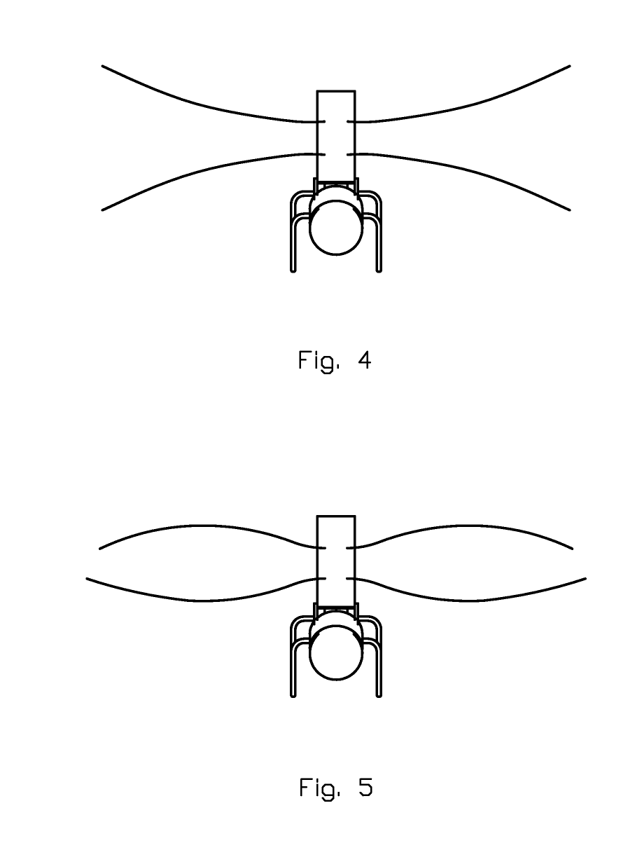

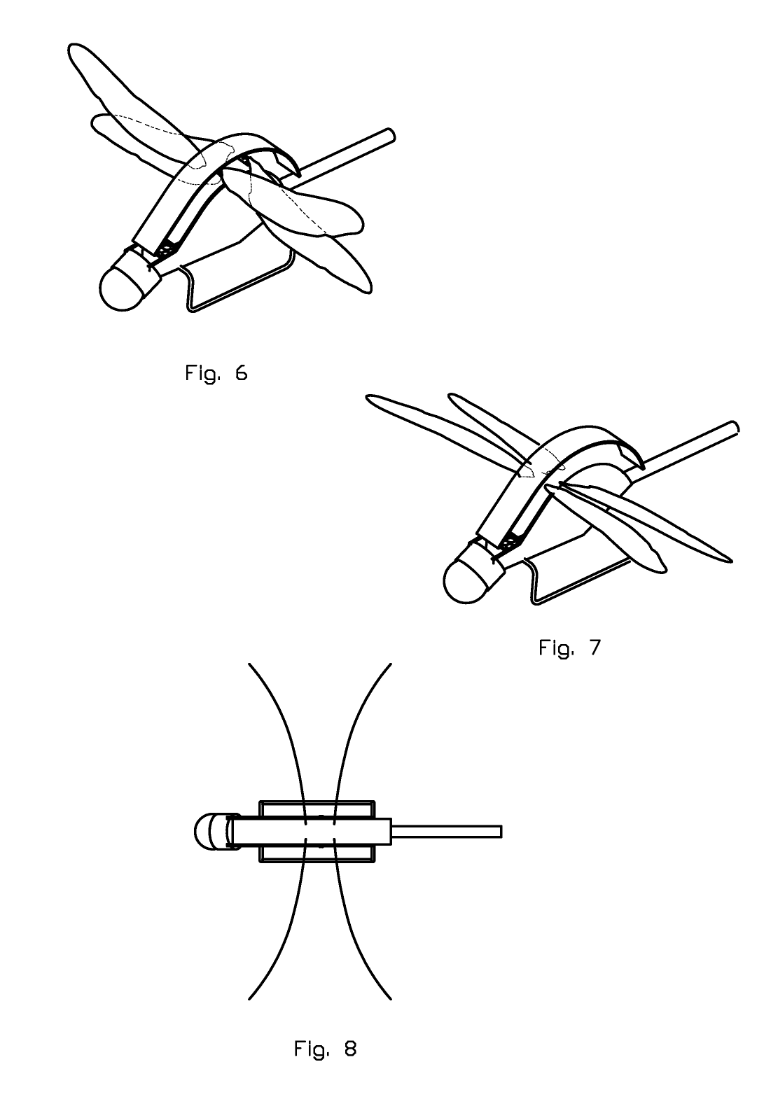

FIGS. 6-7 demonstrate examples of different blade-wing positioning for different flight modes. In a preferred embodiment, illustrated in FIG. 7, vertical flight (take-off and landing) and hovering flight modes are obtained by locating the wings in a vertical position, as illustrated. On the other hand, FIG. 6 demonstrates another preferred embodiment, where the wings are positioned for transition flight mode. In another preferred embodiment transition from vertical take-off and landing and hovering flight modes to horizontal flight modes and back, is obtained by changing the direction of thrust by a pitch rotation of the blades-wings.

The MAV, as disclosed above, may be capable of horizontal, hovering and vertical flight up to two hours, with a range of up to six miles. Typical dimensions of a preferred embodiment may be less than 6 inches long, and weighing less then 0.31 lb. However these are merely examples and other dimensions are possible.

It should be clear that the description of the embodiments and attached Figures set forth in this specification serves only for a better understanding of the invention, without limiting its scope.

It should also be clear that a person skilled in the art, after reading the present specification could make adjustments or amendments to the attached Figures and above described embodiments that would still be covered by the present invention.

1. A micro aerial vehicle apparatus capable of flying in different flight modes, the apparatus comprising:
a fuselage;
at least one pair of blade-wings; and
an actuator for actuating the blade-wings by flapping the blade-wings in dissonance or resonance frequencies.

2. The apparatus as claimed in claim 1 wherein each blade-wing comprises a main beam with flexibility that is different at one or more places along the beam than the flexibility of the beam at other places along the beam.

3. The apparatus as claimed in claim 2, wherein the flexibility at said one or more places along the main beam is greater than the flexibility of the beam at other places along the beam.

4. The apparatus as claimed in claim 1, wherein a weight is provided at a distal tip of each blade-wing.

5. The apparatus as claimed in claim 1, wherein a damper is further provided on each blade-wing.

6. The apparatus as claimed in claim 1, wherein said blade-wings capable of changing their angle.

7. The apparatus as claimed in claim 1, comprising two pairs of blade-wings.

8. The apparatus as claimed in claim 7, wherein a first pair of blade-wings is located at an anterior part of the fuselage, and a second pair of blade-wings is located at a posterior part of the fuselage in a tandem set-up.

9. A method for flying a micro aerial vehicle apparatus comprising at least one pair of blade-wing, the method comprising flapping the blade-wings in dissonance or resonance frequencies.

10. The method as claimed in claim 9, wherein thrust, pitch, yaw and roll flight control are provided by changing the amplitudes of returnable forward-rotary actuations of each blade-wing.

11. The method as claimed in claim 9, further comprising altering the position and angle of the blade-wings.

12. The method as claimed in claim 9, wherein thrust for high endurance horizontal flight is obtained by exciting frequencies of returnable forward-rotary actuations to be equal to values of natural self-frequency of the blade-wings in first dissonance mode of bending.

13. The method as claimed in claim 9, wherein thrust, pitch, yaw and roll flight control are provided by changing amplitudes of returnable forward-rotary actuations of each blade-wing.

14. The method as claimed in claim 9, wherein angle and flapping amplitude of each wing is independent of the other wings.
